(19) United States
(12) Patent Application Publication
(10) Pub. No.: US 2006/0187385 A1
(43) Pub. Date: Aug. 24, 2006

(54) Flexible transflective device and manufacturing method thereof

(76) Inventors: Chi-Chang Liao, Tai Nan City (TW); Ku-Hsien Chang, Kao Hsiung Hsien (TW); Shie-Chang Jeng, Ping Tung Hsien (TW)

Correspondence Address: RABIN & Berdo, PC, 1101 14TH STREET, NW, SUITE 500, WASHINGTON, DC, 20005, US

(21) Appl. No.: 11/201,211

(22) Filed: Aug. 11, 2005

(30) Foreign Application Priority Data
Feb. 22, 2005 (TW) 94105189

(51) Int. Cl. G02F 1/1335

(52) U.S. Cl. 349/114

(57) ABSTRACT

A flexible transflective LCD device having a dual-polarizer structure is manufactured by means of coating the thin-film polarizer therein. The object of the present invention is to solve a drawback of the conventional LCD incapable of being flexible. Multiple supporting microstructures and an external flexible light source collocated with the flexible components and the means of coating method are incorporated to form the flexible transflective LCD device with dual polarizers.

### BACKGROUND OF THE INVENTION

1. Field of the Invention

The present invention is related to a flexible transflective liquid-crystal-display (LCD) device and a manufacturing method thereof, and more particularly, to a flexible transflective LCD device made according to a single-cell-gap design. The flexible transflective LCD device is formed with multiple supporting microstructures and a dual-polarizer structure made according to the technologies of producing flexible components and coating thin film polarizer.

2. Description of Related Art

In general, when a transmissive display is placed outdoors or under intense light, the contrast of images shown thereon is lowered due to the influence of environmental light. Comparatively, since a reflective display relies on an external light source to display images, it has better performance or higher contrast outdoors or under intense light. In addition, the reflective display reduces the power consumption because back light is not required. Thus, the reflective display is very suitable for use in portable products. However, when the environmental light is insufficient, the contrast and brightness of the reflective display are degraded greatly. Hence, a transflective display that modulates light from an external source by reflection and from another source by transmission through a transmission region could have the advantages of the reflective display and the transmissive display at the same time. The transflective display can be driven passively, and furthermore, the transflective display can also be driven actively by thin film transistors (TFTs).

A related art, such as a TN-mode TFT-LCD with in-cell polarizers proposed by Sony Company, Optiva Company, and Nakan Company in the Society for Information Display, in 2004, is shown in FIGS. 1a-b. Thin crystal films (TCFs) are coated in-cell to provide the functionality of polarization. The built-in reflector is coated with a TCF to overcome the parallax problem caused by the thick polarizing sheet conventionally used. Furthermore, images are not inverted thereby. Thus, this technique fulfills the requirements for making a transflective LCD device with a dual-polarizer structure under a single-cell-gap architecture. In the structure shown in FIG. 1a, thin crystal films 10 are coated directly on conductive layers 12 and the conductive layers 12 are coated on a color filter 14 and on an organic layer 16. The difference between the structures shown in FIG. 1a and FIG. 1b is that the thin crystal films 10 of the structure shown in FIG. 1b are respectively formed below the color filter 14 and between the organic layer 16 and a specific layer 18 for deployment of signal lines. However, this related art is applied on a glass substrate and its structure does not fulfill the requirements of next generation technology for a flexible display.

### SUMMARY OF THE INVENTION

An objective of the present invention is to provide a flexible transflective LCD device. The present invention uses technologies of producing flexible components and coating TCFs together to produce the flexible transflective LCD device with a dual-polarizer structure under a design with single-cell-gap architecture. The present invention has a simple manufacturing procedure and a flexible feature that can be used to extend the applicable area of LCD devices.

For reaching the objective above, the present invention provides a flexible transflective LCD device and its manufacturing method. The flexible transflective LCD device includes a first flexible substrate, a second flexible substrate and a liquid crystal layer sandwiched by the first and second substrates. A reflective plate is formed on an internal surface of the second flexible substrate to define the reflective area. The transmissive area is the region located above the second flexible substrate that doesn't have the reflective plate. A polarization layer is provided on the first flexible substrate and on the internal surface of the second flexible substrate in the reflective and transmissive areas. A conductive layer is provided on the internal surface of the first flexible substrate and on the second flexible substrate in the reflective and transmissive areas; multiple supporting microstructures are formed between the first flexible substrate and the second flexible substrate. A flexible light source is attached on an external surface of the second flexible substrate.

The manufacturing method of the present invention includes the following steps. A first flexible substrate and a second flexible substrate are provided. A color filter is provided on the first flexible substrate. The first flexible substrate is coated with a first polarization layer. A conductive layer is provided on the first polarization layer. A reflective plate is provided on the second flexible substrate. The reflective plate is located in a reflective area. A conductive layer is provided on the second flexible substrate. The second flexible substrate is coated with second polarization layer. Multiple supporting microstructures are provided between the first flexible substrate and the second flexible substrate. A plurality of liquid crystal is filled between the first flexible substrate and the second flexible substrate to form a liquid crystal layer. Finally, a flexible light source is attached on an external surface of the second flexible substrate.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1a is a schematic diagram of the prior art, formed with thin crystal films (TCFs) to provide the functionality of polarization;

FIG. 1b is schematic diagram of the prior art formed with TCFs to provide the functionality of polarization;

FIG. 2 is a schematic diagram of a preferred embodiment in accordance with the present invention;

FIG. 3 is a manufacturing procedure of the device in accordance with the present invention;

FIG. 4 shows the flexible transflective LCD device of the present invention when it is in a bright status; and

FIG. 5 shows the flexible transflective LCD device of the present invention when it is in a dark status.

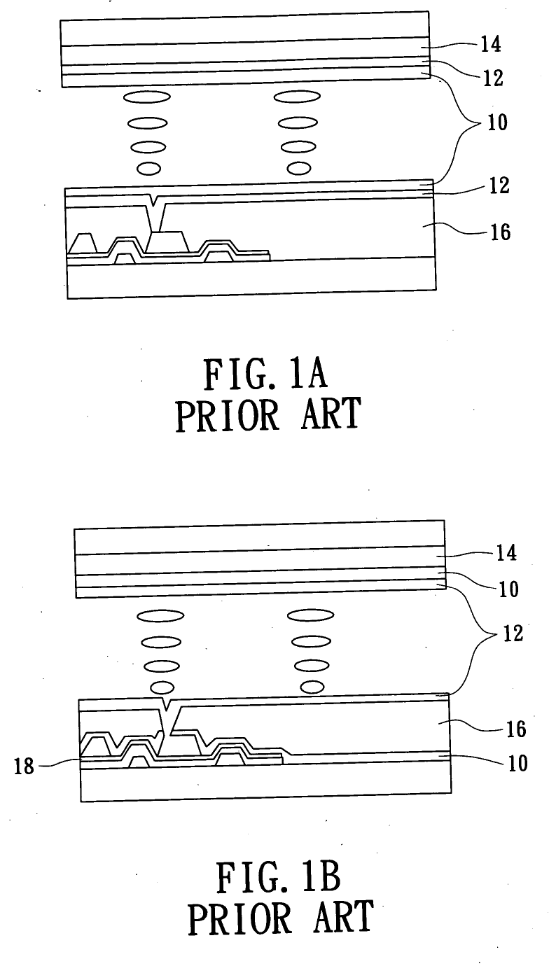

### DETAILED DESCRIPTION OF PREFERRED EMBODIMENTS

The present invention uses the current developing technologies of flexible components and coating polarizer and provides multiple supporting microstructures inside the flexible substrates. The transflective LCD device can be made with a flexible feature and thus the field of application is extended. Furthermore, the manufacturing procedure can also be simplified to lower the cost.

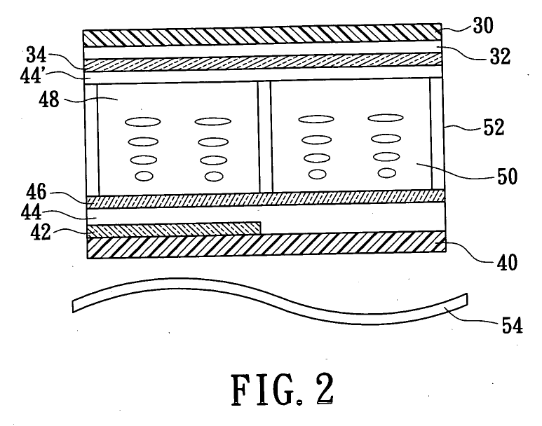

The present invention employs the current developing technologies of flexible components and coating polarizer to produce a flexible transflective LCD device. A structure of a preferred embodiment in accordance with the present invention is shown in FIG. 2. The structure forms a flexible transflective LCD device that mainly includes a first flexible substrate 30, a second flexible substrate 40, multiple supporting microstructures 52 and a liquid crystal layer. As shown in the figure, a cell is formed between the first flexible substrate 30 and the second flexible substrate 40. The cell includes reflective areas 48 and transmissive areas 50. The first flexible substrate 30 and the second flexible substrate 40 are flexible transparent substrates, such as Polyesterurethane (PET), Polyethersulfone (PES) and Metallocene-based Cyclic Olefin Copolymer (MCOC).

The structure of the flexible transflective LCD device further has a color filter 32 formed on an internal surface of the first flexible substrate 30 to form a flexible color LCD. A reflective plate 42 disposed on an internal surface of the second flexible substrate 40. The region above the second flexible substrate 40 having the reflective plate 42 forms the first region (reflection region), and another region above the second flexible substrate 40 that doesn't have the reflective plate 42 forms the second region (transmission region). A conductive layer 44 is formed on the first and second regions. A polarization layer 34 is provided on the color filter 32 of the first flexible substrate and on the conductive layer 44 of the second flexible substrate 40. Alignment layers (not shown in the figure) are disposed on the inner surfaces of the flexible substrates and they are contiguous with the liquid crystal layer. The polarization layer 34 could be made of disk-like Lyotropic Dichroic dyes or rod-like Lyotropic Dichroic dyes. Multiple supporting microstructures 52 are formed. These supporting microstructures 52 can have a closed type or a non-closed type. They can be formed with any geometrical shape, such as a straight line, a cross, a trident, a rectangle, a circular shape and a honeycomb shape. The liquid crystal layer is formed between the first flexible substrate 30 and the second flexible substrate 40. Finally, a flexible light source 54 is disposed at an external surface of the second flexible substrate 40. The backlight module 54 could be a side-edged type backlight module or a direct 20 type backlight module. A flexible direct type backlight module or a side-edged type backlight with a flexible light guide should be used and located on the external side of the lower substrate in order to form a flexible transflective liquid crystal display. The flexible direct type backlight could be a light source, such as organic light emitting diodes (OLED), polymer light emitting diodes (PLED), an electroluminescent source and a microdischarge source, fabricated on a flexible substrate.

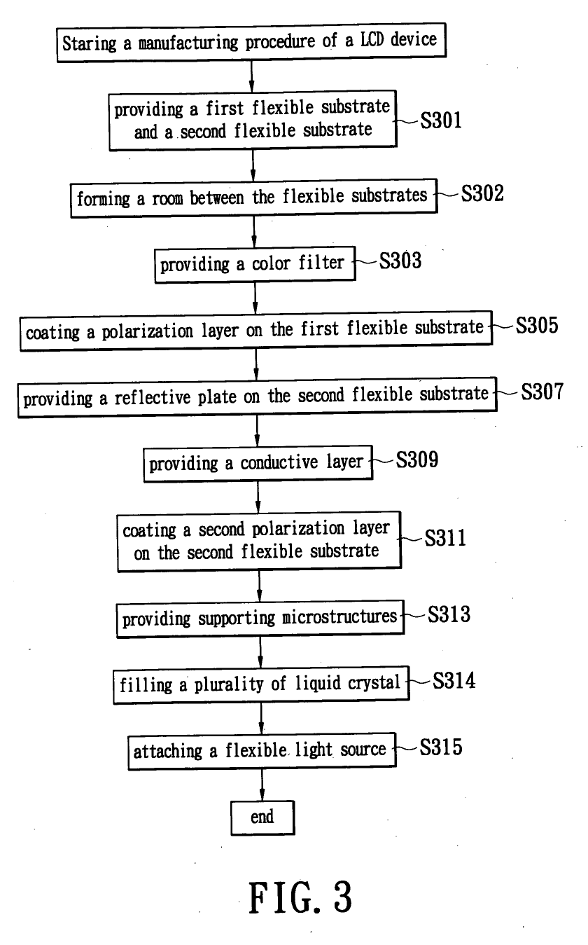

FIG. 3 shows a manufacturing procedure of the flexible transflective display. The first step provides a first flexible substrate 30 and a second flexible substrate 40 (step S301). Then, a color filter 32 is provided on the first flexible substrate 30 (step S303). After that, a first polarization layer 34 is formed on the color filter 32 and then a conductive layer 44′ is further provided on the first polarization layer 34. The location of the first polarization layer 34 on the first flexible substrate 30 is not limited (step S305). The first polarization layer 34 can also be disposed on an external surface of the first flexible substrate 30.

A reflective plate 42 is disposed on an internal surface of the second flexible substrate 40 (step S307). The region above the reflective plate 42 forms the first region of this structure. The other region above the second flexible substrate 40 that doesn't have the reflective plate 42 forms the second region, which is optically transmissive.

Subsequently, a conductive layer 44 is provided on the reflective plate 42 and the second region (step S309). A second polarization layer 46 is provided on the conductive layer 44 (step S311). Multiple supporting microstructures 52 are provided between the first flexible substrate 30 and the second flexible substrate 40 (step S313). The supporting microstructures 52 can be made via a process, such as photolithography, molding, embossing, casting, flexography, printing, coating and photo-induced phase separation process. Then, a plurality of liquid crystal is filled to form a liquid crystal layer (step S314). Finally, a flexible light source 54 is attached to one side of the LCD structure, and is located at an external surface of the second flexible substrate 40 (step S315).

The foresaid first region, i.e. the region above the second flexible substrate 40 having the reflective plate 42, is the reflective region 48 of this structure. The second region above the second flexible substrate 40 with the conductive layer formed thereon without the reflective plate 42 is the transmissive region 50. The conductive layer 44 is a transparent electrode, which can be made of transparent conducting material, such as indium tin oxide (ITO), Poly-3,4-Ethylenedioxythiophene (PEDOT) or Carbon Nanotubes. The reflective plate can be made via a manufacture process, such as sputtering, printing and molding. The material of the reflective plate can be a metal, such as aluminum, or a diffusive material, such as barium sulfate and titanium dioxide.

It is noted that the flexible transflective LCD device of the present invention can be operated in an active mode or a passive mode. In the active mode, the thin film transistors (TFT) can be fabricated under the reflective plate to increase the aperture ratio.

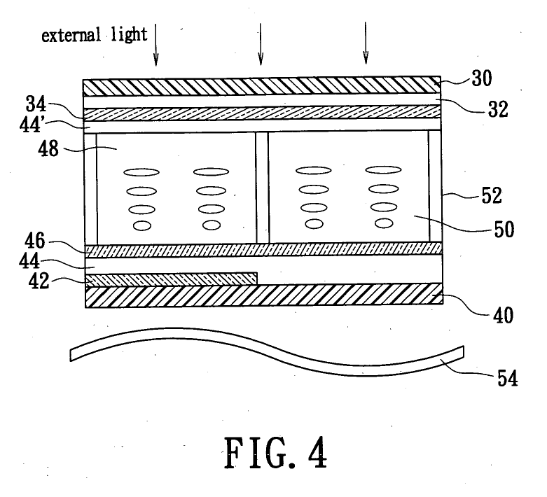

A flexible transflective LCD device of the present invention operated in a bright state is shown in FIG. 4. This figure shows that, when no voltage is provided (i.e. in a voltage-off state), only P-polarized light of the external light enters the reflective area 48 of the liquid crystal layer after the external light passes through the first polarization layer 34 (assume that the first polarization layer 34 absorbs the S-polarized light). Then, the liquid crystal layer makes the incoming P-polarized light to rotate and become a S-polarized light so as to make the incoming light to pass the second polarization layer 46 (assume that the second polarization layer 46 absorbs the P-polarized light). Subsequently, the light is reflected back to the liquid crystal layer by the reflective plate 42. Then, the liquid crystal layer makes the reflected S-polarized light to rotate and become a P-polarized light to pass the first polarization layer 34. Thus, the reflective area 48 is in a bright state.

On the other hand, in the transmissive area 50, when the light emitted from the flexible light source passes through the second polarization layer 46, only S-polarized light enters the liquid crystal layer. Then, after rotation by the liquid crystal layer to form P-polarized light, the light is able to pass through the first polarization layer 34. Thus, the transmissive area 50 is also in a bright state.

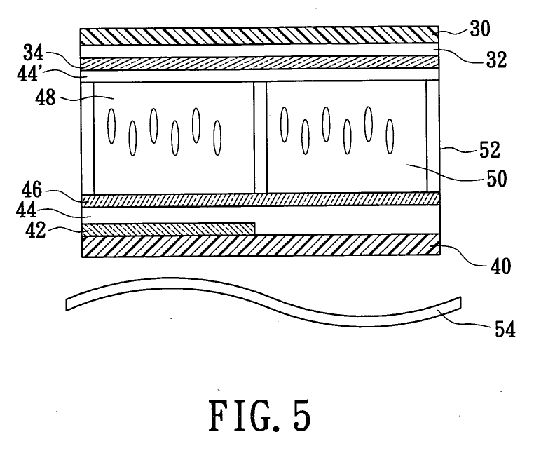

When voltage is provided (i.e. in a voltage-on state), the liquid crystal layer doesn't perform the polarization function. Thus, both the reflective area and the transmissive area are in a dark state as shown in FIG. 5.

Based on the operation principle of this device, the first polarization layer 34 doesn't need to be located between the color filter 32 and the conductive layer 44′. It can be placed on any side of the first flexible substrate 30 or at any layer. The second polarization layer 46 needs to be located above the reflective plate 42 but it could be disposed either above or below the conductive layer 44.

As description above, the present invention uses the flexible components and coating polarization layer to fulfill the requirements of the technology for making a flexible transflective display with a single cell gap. The present invention further uses multiple supporting microstructures to keep a constant cell gap of the display when the display is bent. Furthermore, the manufacturing procedure is roll-to-roll compatible. Thus, the present invention can be used in mass production and for lowering the cost. In addition, the flexible feature of the present invention can be used to extend the field of application for products.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A flexible transflective liquid-crystal-display device, comprising:
a first flexible substrate and a second flexible substrate, a room being formed between the first flexible substrate and the second flexible substrate;
a reflective plate formed on an internal surface of the second flexible substrate;
a first polarization layer provided on the first flexible substrate;
a second polarization layer provided on an upper side of the reflective plate of the second flexible substrate;
a conductive layer provided on the first flexible substrate and the second flexible substrate;
a plurality of supporting microstructures formed between the first flexible substrate and the second flexible substrate;
a plurality of liquid crystal formed between the first flexible substrate and the second flexible substrate; and
a flexible light source attached on an external surface of the second flexible substrate.

2. A flexible transflective LCD device as claimed in claim 1, further comprising alignment layers, disposed on an internal side of the flexible substrates and contiguous with the liquid crystal layer.

3. A flexible transflective LCD device as claimed in claim 1, further comprising a color filter, disposed on an internal side of the flexible substrate to form a flexible color transflective LCD device.

4. A flexible transflective LCD device as claimed in claim 1, wherein the first polarization layer is disposed on any side and at any layer of the first flexible substrate and the second polarization layer is disposed above the reflective plate.

5. A flexible transflective LCD device as claimed in claim 1, wherein the flexible substrate are transparent and made of Polyesterurethane (PET), Polyethersulfone (PES) or Metallocene-based Cyclic Olefin Copolymer (MCOC).

6. A flexible transflective LCD device as claimed in claim 1, wherein a region located above the second flexible substrate having the reflective plate forms a reflective area and a region located above the second flexible substrate without the reflective plate forms a transmissive area.

7. A flexible transflective LCD device as claimed in claim 1, wherein a material of the reflective plate is aluminum, barium sulfate or titanium dioxide.

8. A flexible transflective LCD device as claimed in claim 1, wherein a material of the polarization layers is disk-like Lyotropic Dichroic dyes or rod-like Lyotropic Dichroic dyes.

9. A flexible transflective LCD device as claimed in claim 1, wherein the conductive layer is a transparent electrode and made of indium tin oxide (ITO), Poly-3,4-Ethylenedioxythiophene (PEDOT) or Carbon Nanotubes.

10. A flexible transflective LCD device as claimed in claim 1, wherein the supporting microstructures has a closed type or a non-closed type, such as a straight-line shape, a cross shape, a trident shape, a rectangular shape, a circular shape and a honeycomb shape.

11. A flexible transflective LCD device as claimed in claim 1, wherein the flexible light source is a flexible direct type backlight module or a side-edged type backlight module with a flexible light guide provided on the external surface of the second flexible substrate.

12. A flexible transflective LCD device as claimed in claim 11, wherein the flexible direct type backlight module is made of organic light-emitting diodes (OLEDs), polymer light-emitting diodes (PLEDs), electroluminescent (EL) components or microdischarge components.

13. A method for manufacturing a flexible transflective LCD device, comprising:
providing a first flexible substrate and a second flexible substrate;
coating a first polarization layer on the first flexible substrate;
providing a conductive layer on the first polarization layer;
providing an alignment layer on the conductive layer;
providing a reflective plate on the second flexible substrate, wherein the reflective plate is located in a reflective area;
providing a conductive layer on the second flexible substrate;
coating a second polarization layer on the second flexible substrate;
providing an alignment layer on the conductive layer;
providing a plurality of supporting microstructures between the first flexible substrate and the second flexible substrate;
filling a plurality of liquid crystal to form a liquid crystal layer between the first flexible substrate and the second flexible substrate; and
attaching a flexible light source on an external surface of the second flexible substrate.

14. A method for manufacturing a flexible transflective LCD device as claimed in claim 13, further comprising a color filter disposed at an internal side of the flexible substrate to form a flexible color transflective LCD device.

15. The method as claimed in claim 13, wherein the color filter is fabricated via a photolithography process or an inkjet printing process.

16. The method as claimed in claim 13, wherein the polarization layers are formed via a coating process.

17. The method as claimed in claim 13, wherein a transparent electrode is provided via a sputtering process, a printing process or an ink-jet printing process.

18. The method as claimed in claim 13, wherein the supporting microstructures are made via a photolithography process, a molding process or a photo-induced phase separation process.

19. The method as claimed in claim 13, wherein when the flexible transflective LCD device is operated in an active mode, the thin film transistors (TFT) are fabricated under the reflective plate to increase an aperture ratio.
